(19) United States
(12) Patent Application Publication
(10) Pub. No.: US 2018/0122002 A1
(43) Pub. Date: May 3, 2018

(54) METHOD AND SYSTEM FOR TRANSACTIONAL DEBT REPAYMENT

(71) Applicant: MasterCard International Incorporated, Purchase, NY (US)

(72) Inventor: James Patrick KELLY, Stamford, CT (US)

(73) Assignee: MasterCard International Incorporated, Purchase, NY (US)

(21) Appl. No.: 15/340,169

(22) Filed: Nov. 1, 2016

(51) Int. Cl. G06Q 40/02; G06Q 20/34

(52) U.S. Cl. CPC G06Q 40/025; G06Q 20/34

(57) ABSTRACT

A method for modification of loan terms based on transaction account activity includes: storing an account profile, the profile including loan terms associated with a loan, a primary account number, and transaction values related to payment transactions funded by a related transaction account; receiving a transaction message for a payment transaction including the primary account number and additional transaction data; verifying exceeding of a usage threshold based on a combination of the transaction values stored in the account profile and the additional transaction data; and modifying the loan terms based on a result of the verification.

### FIELD

The present disclosure relates to the modification of debt repayment terms based on transaction account activity, specifically the analysis of transaction account activity to determine when usage thresholds are met, which triggers the modification of terms for debt repayment to encourage specified transactional behavior.

### BACKGROUND

There are a wide variety of loans that the average consumer may apply for and receive throughout their lifetime. Consumers get automotive loans for the purchase of a new vehicle, student loans to finance their education, mortgages for the purchase of a house, home equity loans to finance repairs and refurnishing, etc. In many cases, a consumer may receive a loan and may repay the loan in compliance with the loan terms without any incident. However, there are many instances where a consumer may fail to repay a loan, where the lending institution is forced to take action against the consumer to recover their investment.

In some cases, the consumer may fail to repay the loan because of actions beyond their control. However, there are also cases where a consumer may, often unknowingly, spend beyond their means or make other financial decisions that render themselves unable to repay the loan. Unfortunately, lending institutions are often unaware of these situations and the transactional behavior of the consumers to whom they lend. In addition, the consumers themselves often lack direction and assistance in the monitoring of their transaction behavior to ensure the ability to repay the loan.

Thus, there is a need for a technological solution to assist, and incentivize, consumers with the monitoring of their transactional behavior for loan repayment. Such a solution may provide for more consistent repayment of loans, which may be more profitable for lending institutions, protective of consumer credit, and educational for consumer spending.

### SUMMARY

The present disclosure provides a description of systems and methods for the modification of loan terms based on transaction account activity. Modifying loan terms based on transaction account activity may provide for a strong incentive to consumers to monitor and manage their transactional behavior, by providing them with assistance in loan repayment. The use of usage thresholds to trigger the modification of loan terms may enable lending institutions to set transactional goals to ensure that consumers are in a position to repay the loan over the life of repayment, with the corresponding modifications providing the incentive to meet the goals.

A method for modification of loan terms based on transaction account activity includes: storing, in an account database of a processing server, an account profile, wherein the account profile is a structured data set related to a transaction account including at least one or more loan terms associated with a loan, a primary account number, and transaction values, the transaction values being related to a plurality of payment transactions funded by the related transaction account; receiving, by a receiving device of the processing server, a transaction message for a payment transaction, wherein the transaction message is formatted based on one or more standards and includes a plurality of data elements including at least a first data element configured to store the primary account number and one or more additional data elements configured to store additional transaction data; verifying, by a verification module of the processing server, exceeding of a usage threshold by the related transaction account based on at least a combination of the transaction values stored in the account profile and the additional transaction data; and executing, by a querying module of the processing server, a query on the account database to modify at least one of the one or more loan terms based on a result of the verification.

A system for modification of loan terms based on transaction account activity includes: an account database of a processing server configured to store an account profile, wherein the account profile is a structured data set related to a transaction account including at least one or more loan terms associated with a loan, a primary account number, and transaction values, the transaction values being related to a plurality of payment transactions funded by the related transaction account; a receiving device of the processing server configured to receive a transaction message for a payment transaction, wherein the transaction message is formatted based on one or more standards and includes a plurality of data elements including at least a first data element configured to store the primary account number and one or more additional data elements configured to store additional transaction data; a verification module of the processing server configured to verify exceeding of a usage threshold by the related transaction account based on at least a combination of the transaction values stored in the account profile and the additional transaction data; and a querying module of the processing server configured to execute a query on the account database to modify at least one of the one or more loan terms based on a result of the verification.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for modifying loan terms based on transaction account activity in accordance with exemplary embodiments.

FIG. 2 is a block diagram illustrating the processing server of FIG. 1 for the modification of loan terms based on transaction account activity in accordance with exemplary embodiments.

FIG. 3 is a flow diagram illustrating a process for the modification of terms of a loan based on the meeting of usage thresholds by a transaction account using the system of FIG. 1 in accordance with exemplary embodiments.

FIG. 4 is a flow diagram illustrating a process for the modification of terms for loan repayment based on transaction account activity using the processing server of FIG. 2 in accordance with exemplary embodiments.

FIG. 5 is a flow chart illustrating an exemplary method for modification of loan terms based on transaction account activity in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Modification of Loan Terms Based on Transaction Account Activity

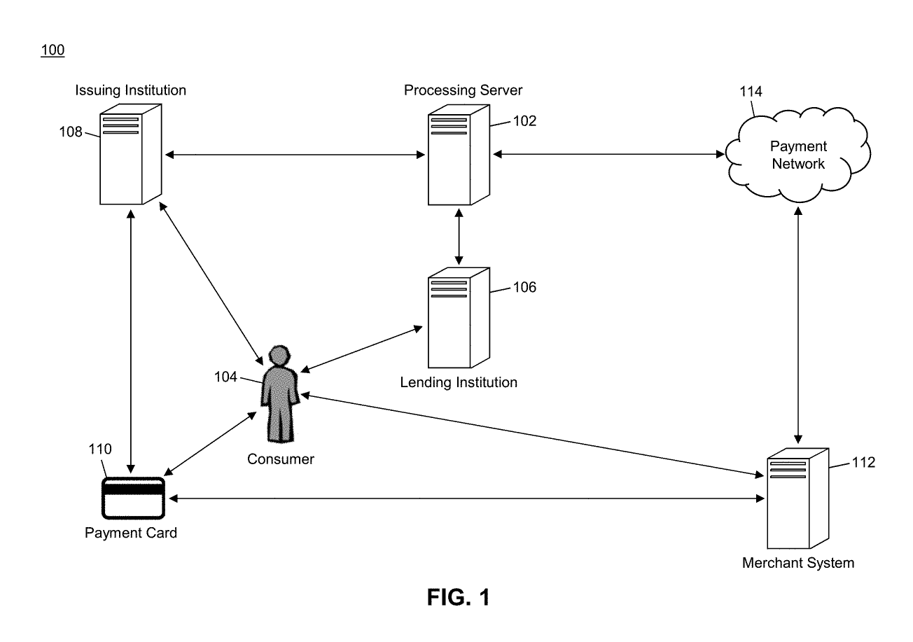

FIG. 1 illustrates a system 100 for the modification of terms for loan or other debt repayment based on activity of a transaction account and corresponding usage thresholds.

The system 100 may include a processing server 102. The processing server 102, discussed in more detail below, may be configured to modify loan terms based on activity of a transaction account, more specifically to modify loan terms once the transaction activity for a transaction account reaches a predetermined threshold. In the system 100, a consumer 104 may receive a loan from a lending institution 106. The lending institution 106 may be a financial institution or any other type of entity that may provide any suitable types of loans to consumers. The loan that is leant to the consumer 104 may be any loan that has one or more terms that may be modified as a result of the processes discussed herein based on their transaction account activity. Such loan terms may include, for example, interest rate, principal amount, interest amount, payment period, number of payments, payment amount, annual percentage rate, associated fees, etc.

To participate in the platform provided via the processing server 102, the lending institution 106 may register the consumer's loan with the processing server 102. Such registration may include providing the processing server 102 with loan terms associated with the loan and information identifying the consumer 104. In some instances, the lending institution 106 may provide all loan terms for the loan. In other instances, the lending institution 106 may only provide loan terms that may be modified via the processes discussed herein. In some embodiments, the processing server 102 may be a part of the computing systems of the lending institution 106. In other embodiments, the processing server 102 may be external to the lending institution 106 and may communicate with the lending institution 106 via the exchange of data signals superimposed or otherwise encoded with data that are exchanged via one or more suitable communication networks and methods.

In order to monitor transaction activity of the consumer 104, one or more transaction accounts associated with the consumer 104 may also be registered with the processing server 102. The transaction accounts may be transaction accounts issued to the consumer 104 from an issuing institution 108. The issuing institution 108 may be a financial institution or other entity configured to issue transaction accounts that are suitable for use in funding electronic payment transactions. In some embodiments, the processing server 102 may contact the issuing institution 108 to request the transaction account information, using the identifying information provided by the lending institution 106 during registration of the loan. In other embodiments, the processing server 102 may be a part of the issuing institution 108 and may access the transaction account data using internal communication methods. In yet other embodiments, the lending institution 106 may provide the transaction account information as part of registration. In some such embodiments, the lending institution 106 may also be the issuing institution 108, or may have an agreement with the issuing institution 108 for providing of the transaction account information (e.g., such as may be gathered as part of the lending process for the loan). Identification information that may be used to identify the consumer 104 for registration of the loan and transaction accounts may be any information suitable for identification of a consumer 104 and corresponding transaction accounts, such as an identification number, primary account number (e.g., corresponding to one of the transaction accounts), username, e-mail address, phone number, registration number, loan number (e.g., corresponding to the loan), etc.

After registration of the loan and transaction account(s), the consumer 104 may participate in payment transactions using the registered transaction account(s). As part of the issuing of a transaction account to the consumer 104, the issuing institution 108 may issue a payment card 110 or other suitable type of payment instrument to the consumer 104. The payment card 110 may be encoded with, or otherwise configured to access, payment credentials associated with the corresponding transaction account. The consumer 104 may present the payment card 110 to a merchant system 112 of a merchant, such as via a point of sale device, to convey the payment credentials associated therewith to the merchant system 112. Methods for conveying payment credentials will be apparent to persons having skill in the relevant art and include, for example, the reading of data encoded in a magnetic strip of the payment card 110, electronic transmission of data stored in the payment card 110 via near field communication, display of a machine-readable code by the payment card 110 that is encoded with the payment credentials, etc.

The merchant system 112 may receive the payment credentials and may electronically transmit the payment credentials with additional transaction data for the payment transaction to a payment network 114 for processing. The merchant system 112 may electronically transmit the transaction data to the payment network 114 directly via payment rails associated therewith, or may electronically transmit the transaction data to one or more intermediate entities for reformatting and/or forwarding to the payment network 114, such as an acquiring institution or gateway processor. The transaction data may be formatted in a transaction message that is received by the payment network 114, either by the merchant system 112 or by one of the intermediate entities, as applicable. A transaction message may be a specially formatted data message that is formatted pursuant to one or more standards governing the exchange of financial transaction messages, such as the International Organization of Standardization's ISO 8583 or ISO 20022 standards.

Transaction messages may include message type indicators that are indicative of a type of the corresponding transaction message. Transaction messages may also include a plurality of data elements, where each data element is configured to store transaction data. For instance, a transaction message may include a first data element configured to store a primary account number, a second data element configured to store a transaction amount, a third data element configured to store a transaction time, a fourth data element configured to store a transaction date, etc. Additional transaction data that may be stored in the data elements of a transaction message may include payment credentials, geographic location, merchant data, consumer data, issuer data, acquirer data, currency data, product data, reward data, loyalty data, point of sale data, offer data, etc. In some embodiments, a transaction message may include one or more bitmaps, which may be configured to indicate the data elements included in the transaction message and the data stored therein.

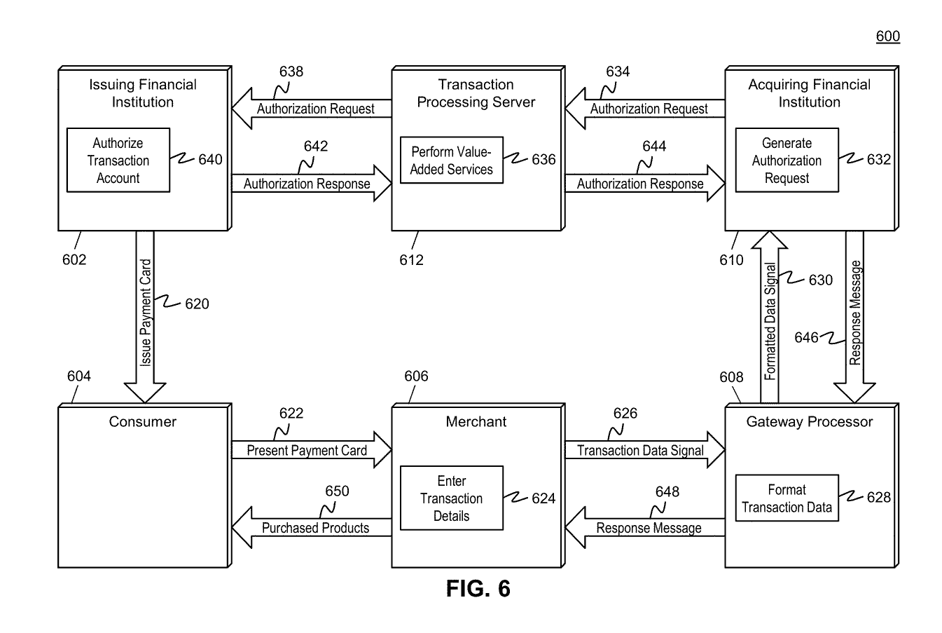

The payment network 114 may receive the transaction message and may be configured to process the payment transaction based on data included therein using traditional methods and systems. As part of the processing of the payment transaction, the payment network 114 may, for example, forward an authorization request (e.g., a transaction message with a message type indicator indicating thusly) to the issuing institution 108, which may return an authorization response that includes a data element configured to store a response code indicating approval or denial of the transaction, which may be forwarded by the payment network 114 to the merchant system 112 and/or one of the intermediate entities. Additional data regarding the processing of payment transactions is discussed in more detail below with respect to the process 600 illustrated in FIG. 6.

The processing server 102 may be configured to receive transaction data for a payment transaction involving the consumer 104, which may be funded via one of the registered transaction accounts. In some embodiments, the payment network 114 may electronically transmit the transaction message or data included therein to the processing server 102 via the payment rails associated therewith or another suitable communication network. In other embodiments, the processing server 102 may be a part of the payment network 114 and may receive the transaction message via internal communication methods of the payment network 114. In yet other embodiments, the issuing institution 108 may electronically transmit the authorization request or response for the payment transaction to the processing server 102 for use in the processes discussed herein. In embodiments where the processing server 102 may be a part of the issuing institution 108, the processing server 102 may receive the transaction message as part of the processing of the payment transaction by the issuing institution 108.

The processing server 102 may receive the transaction message and may update the transaction account activity of the consumer 104 based thereon. The processing server 102 may repeat the process for additional payment transactions that are conducted by the consumer 104 using the registered transaction accounts. The processing server 102 may continue to update and monitor the transaction account activity and determine, with each payment transaction, if the consumer's activity exceeds a usage threshold. Usage thresholds may be set by the lending institution 106 associated with the loan, the issuing institution 108 associated with the registered transaction accounts, the processing server 102, a regulatory agency, or other suitable entity, and may be thresholds that, once exceed, result in modification of the loan terms. Usage thresholds may be used to provide an incentive to the consumer 104 to follow behavior determined to be desirable by the associated entity where following of the behavior may result in modification of the loan terms to be favorable towards the consumer 104. In some instances, usage thresholds may be based on the type of loan, and loan terms that are modified based on the exceeding of a usage threshold may be based on the usage threshold itself.

For instance, in a first example, a usage threshold may be a minimum aggregate spending amount during a month, which may be evaluated on a monthly basis or an ongoing basis (e.g., must spend at least a predetermined amount each month for three months in a row). In a second example, a usage threshold may be a minimum number of transactions conducted during predetermined periods of time (e.g., at least ten transactions a month for four months). In a third example, a usage threshold may be a limit on the aggregate spending amount during a predetermined period of time (e.g., must spend less than $1,000 a month for six months). In a fourth example, the usage threshold may be a minimum amount of aggregate spending in a specific merchant industry during a predetermined period of time (e.g., must spend $5,000 at home improvement merchants during a three month period). In such examples, the usage thresholds may be used to ensure compliance with desired transaction behavior. For instance, a lending institution 106 may be concerned that the consumer 104 may overspend and be unable to repay the loan, and may set a usage threshold for a maximum spending amount to incentive the consumer 104 to spend less. In another instance, a lending institution 106 providing a loan for home improvement may set a usage threshold to help ensure that the loan is actually used for home improvement projects.

In some cases, the loan terms that are modified may be based on, or otherwise associated with, the usage thresholds. For example, in the above home improvement loan, the lending institution 106 may set a usage threshold for minimum home improvement spending that may, if met, lower the loan's interest rate, as well as a usage threshold for minimum overall spending that, if met, may lower the loan's principal balance. In some instances, multiple usage thresholds of the same type may be set for a loan, where meeting of the usage thresholds may result in continual modification to the same loan term. For example, in the home improvement loan example, once the consumer 104 has spent $1,000 at home improvement merchants the loan's interest rate may drop from 8% to 7%, and may drop again from 7% to 6% once $3,000 has been spent, and may finally drop from 6% to 4% once $10,000 has been spent. As a result, a lending institution 106 or other institution may use a combination of usage threshold types and levels and the corresponding loan term modifications to incentivize a consumer 104 to follow desired transaction behavior.

Once the processing server 102 determines that a usage threshold has been exceeded, the processing server 102 may modify the loan terms for the corresponding loan as indicated. In some embodiments, the processing server 102 may modify the loan terms via modification to registered loan data stored locally in the processing server 102 (e.g., or in the lending institution 106 in embodiments where the processing server 102 is part of the lending institution 106). In other embodiments, the processing server 102 may electronically transmit a data signal to the lending institution 106 that is superimposed or otherwise encoded with data indicating that the usage threshold has been met/exceeded and/or that a specific loan term has been modified and the result of the modification. The lending institution 106 may then modify the loan terms accordingly. In some instances, the processing server 102 and/or lending institution 106 may inform the consumer 104 of the modification of their loan terms, such as via an associated computing device or other suitable contact method, such as may be registered by the consumer 104 and/or lending institution 106 during registration of the loan.

In some embodiments, the processing server 102 may also be configured to use transaction controls as a further method for ensuring consumer transaction behavior. Transaction controls may be controls that are placed on a transaction account that are applicable to one or more payment transactions that must be complied with for a payment transaction to be approved. Transaction controls may include controls on spending amount, aggregate spending amount, geographic location, transaction time, transaction data, merchant name, merchant industry, merchant category code, product name, product type, etc., and may be applicable on a per-transaction, per-number of transactions, and/or period of time basis. Additional details regarding transaction controls may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

Transaction controls may be stored in the processing server 102 and applied to payment transactions. In such embodiments, the processing server 102 may receive the authorization request for a payment transaction during processing of the payment transaction. For instance, the processing server 102 may be a part of the payment network 114 and may receive the authorization request before forwarding to the issuing institution 108, may be external to the payment network 114 and issuing institution 108 and may receive the authorization request from the payment network 114 for application of transaction controls prior to forwarding the authorization request to the issuing institution 108, or may be a part of the issuing institution 108 and may apply transaction controls during the traditional processing performed by the issuing institution 108. Application of the transaction controls may be a determination by the processing server 102 if a payment transaction is in compliance with the transaction controls based on the transaction data for the payment transaction, parsed from the authorization request, and, if applicable, may be further based on past transaction data as may be stored in a profile associated with the consumer 104 and/or the corresponding transaction account. In some instances, if a payment transaction is not in compliant with transaction controls, the processing server 102 may generate an authorization response indicating denial of the payment transaction, which may be forwarded directly to the payment network 114, without requiring the issuing institution 108 to process the payment transaction.

Methods and systems discussed herein may enable a processing server 102 to monitor transaction behavior for a consumer 104 to determine if the consumer 104 meets usage thresholds that encourage following desired transaction behavior, which may be incentivized by the modification of loan terms for a loan issued to the consumer 104. The use of a dedicated platform of the processing server 102 may provide for the lending institution 106 to provide such incentive to a consumer 104 without any modification to existing computing systems, and without the need for the lending institution 106 to monitor the consumer's ongoing transaction behavior. In addition, consumers 104 may receive the benefit of more favorable loan terms and may also be provided with data that is useful in directing their own transaction behavior that may otherwise be unavailable to the consumer 104. Furthermore, the use of a dedicated, specially configured processing server 102 as discussed herein may enable the monitoring of transaction behavior for a large number of consumers 104 in systems where tens of thousands, or millions, or even billions, of transactions are processed every day.

### Processing Server

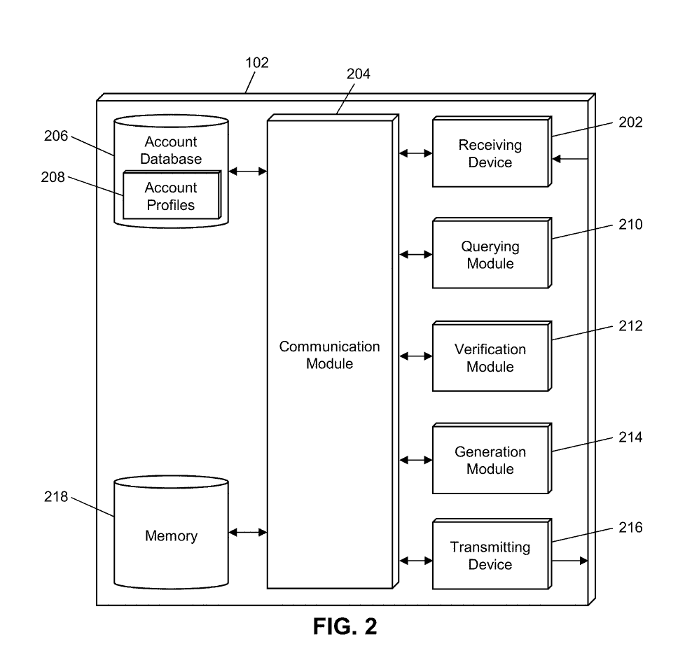

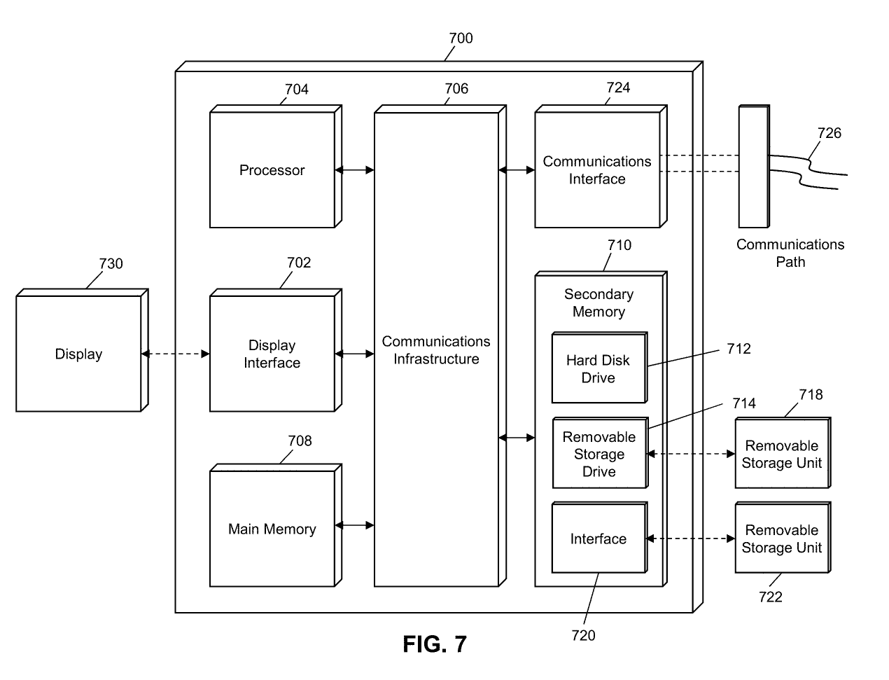

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 114 for the transmission of transaction messages that include sensitive financial data and information. In some instances, the receiving device 202 may also be configured to receive data from lending institutions 106, issuing institutions 108, merchant systems 112, payment networks 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 114 via payment rails associated therewith that may be superimposed or otherwise encoded with transaction messages. Transaction messages may be formatted pursuant to one or more standards, such as the ISO 8583 or ISO 20022 standards, and include a message type indicator and a plurality of data elements, such as data elements configured to store primary account numbers and other transaction data, such as transaction amounts, transaction times, transaction dates, geographic locations, merchant data, product data, etc. The receiving device 202 may also be configured to receive data signals electronically transmitted by lending institutions 106 and issuing institutions 108, which may be superimposed or otherwise encoded with registration data for the registration of loans and transaction accounts for use in conjunction with the methods discussed herein.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, verification module 212, generation module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a registered loan account. Each account profile 208 may include at least one or more loan terms associated with the related loan, one or more primary account numbers, and transaction values. The one or more primary account numbers may each be associated with a transaction account registered as corresponding to the related loan. The transaction values may be values parsed from and/or based on payment transactions involving the registered transaction account(s). In some instances, the transaction values that are stored may be based on usage thresholds applicable to the related loan. In some cases, an account profile 208 may also include usage thresholds or information indicative thereof, such as in instances where usage thresholds may be loan specific.

The processing server 102 may include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify an account profile 208 associated with a received transaction message based on the primary account number stored in a corresponding data element included in the transaction message. The querying module 210 may also be configured to execute queries to update loan terms and transaction values included in an account profile 208, such as based on newly received transactions and the exceeding of usage thresholds.

The processing server 102 may also include a verification module 212. The verification module 212 may be configured to verify data for use in performing the functions of the processing server 102 as discussed herein. The verification module 212 may receive data as input, may verify the data, and may output a result of the verification to another module or engine of the processing server 102. For example, the verification module 212 may be configured to verify if a usage threshold is exceeded based on data included in a received transaction message and, if applicable, transaction values stored in a related account profile 208, such as may be identified via a query executed by the querying module 210. In embodiments where the processing server 102 may apply transaction controls, the verification module 212 may be configured to verify if a payment transaction is in compliance with transaction controls, based on the transaction data stored in the data elements included in a transaction message and stored transaction controls, and, if applicable, also considering the transaction values in the related account profile 208.

The processing server 102 may also include a generation module 214. The generation module 214 may be configured to generate data messages for use by the processing server 102 in performing the functions discussed herein. The generation module 214 may be configured to receive instructions and data for inclusion in a data message, may generate the data message, and may output the generated data message to another module or engine of the processing server 102. In some instances, the generation module 214 may format the data message based on received instructions. In other instances, the generation module 214 may identify formatting rules for formatting of a data message, such as may be stored in a memory 218 of the processing server 102, discussed in more detail below. The generation module 214 may be configured to generate data messages for electronic transmission to lending institutions 106, which may include modified loan terms or data related thereto, such as data associated with the exceeding of usage thresholds by a consumer 104 associated with a loan leant by the lending institution 106, such as the consumer's identifying information and the exceeded usage threshold.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 114 for the transmission of transaction messages that include sensitive financial data and information, such as identified payment credentials. In some instances, the transmitting device 216 may be configured to transmit data to lending institutions 106, issuing institutions 108, merchant systems 112, payment networks 114, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to issuing institutions 108 and payment networks 114 that are superimposed or otherwise encoded with transaction messages. The transaction messages may be formatted pursuant to one or more standards, such as the ISO 8583 and ISO 20022 standards. The transaction messages may be authorization requests or authorization responses, and include a plurality of data elements including data elements configured to store transaction data, including response codes, indications of compliance or non-compliance with transaction controls, etc. The transmitting device 220 may also be configured to electronically transmit data signals to lending institutions 106 that are superimposed or otherwise encoded with data related to the exceeding of usage thresholds, such as modified loan terms, consumer identifying information, indications of exceeded usage thresholds, transaction values related to the exceeding of usage thresholds, etc.

The processing server 102 may also include a memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Process for Modification of Loan Terms

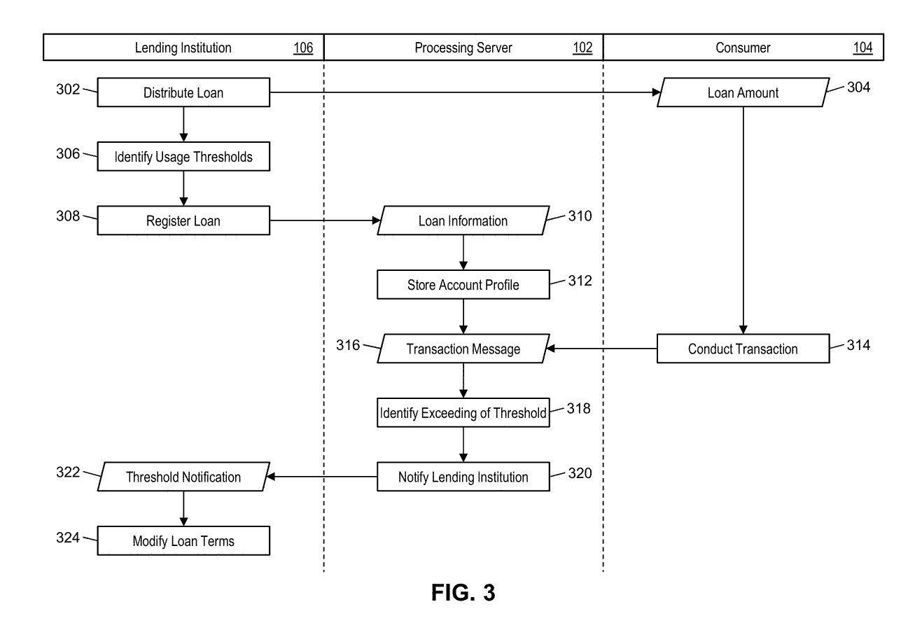

FIG. 3 illustrates a process for the modification of loan terms in the system 100 based on the exceeding of a usage threshold associated therewith based on consumer transaction behavior.

In step 302, the lending institution 106 may distribute a loan to the consumer 104. As part of the distribution of the loan, in step 304, the consumer 104 may receive the loan amount. The loan may be subject to one or more loan terms, which may include a principal balance for repayment, payment amount, number of payments, payment period, interest rate, interest amount, annual percentage rate, etc. In step 306, the lending institution 106 may identify usage thresholds. The usage thresholds may be thresholds that, once exceeded by the consumer 104 based on his or her transaction behavior, result in modification to the loan terms for the loan. In some instances, usage thresholds may be related, such as having multiple thresholds for the same transaction behavior (e.g., aggregate spending in a specific merchant industry). In some instances, specific loan terms may be associated with specific usage thresholds, such that the exceeding of a specific usage threshold results in modification of the associated loan term.

In step 308, the lending institution 106 may register the loan with the processing server 102 for management thereof using the methods and systems discussed herein. Registration may include the electronic transmission of one or more data signals from the lending institution 106 to the processing server 102 that are superimposed or otherwise encoded with loan information. In step 310, the receiving device 202 of the processing server 102 may receive the loan information. The loan information may include at least consumer identification information, one or more loan terms subject to modification, and one or more primary account numbers corresponding to transaction accounts associated with the consumer 104. In step 312, the querying module 210 of the processing server 102 may execute a query on the account database 206 to store a new account profile 208 therein that is related to the loan and includes the received loan information.

In step 314, the consumer 104 may conduct a payment transaction with a merchant system 112. As part of the conducting of the payment transaction, the consumer 104 may provide, to the merchant system 112, payment credentials associated with a registered transaction account, which includes a primary account number included in the loan information that was provided to the processing server 102 in step 310. The merchant system 112 may forward the transaction data, including the primary account number, to the payment network 114 via one or more intermediate entities. The payment network 114 may then forward a transaction message for the payment transaction to the processing server 102, to be received by the receiving device 202 of the processing server 102, in step 316. The transaction message may be formatted pursuant to one or more standards, such as the ISO 8583 and ISO 20022 standards, and include a plurality of data elements including at least a data element configured to store the primary account number and additional data elements configured to store the additional transaction data.

In step 318, the verification module 212 of the processing server 102 may determine that the payment transaction results in the exceeding of a usage threshold. The determination may be based on the transaction data included in the received transaction message and the usage thresholds that were provided for the related loan and stored in the corresponding account profile 208, which may be identified via a query by the querying module 210 using the primary account number stored in the corresponding data element included in the transaction message. In step 320, the generation module 214 of the processing server 102 may generate a data message that indicates that the usage threshold is exceeded, which may be electronically transmitted to the lending institution 106 by the transmitting device 216 of the processing server 102 using a suitable communication network and method.

In step 322, the lending institution 106 may receive the notification that the usage threshold was exceeded. The lending institution 106 may then identify the applicable loan, and, in step 324, may modify one or more loan terms as a result of the exceeding of the usage threshold. In some embodiments, the loan term that is modified may be selected based on the usage threshold that was exceeded. In some instances, the lending institution 106 may provide a notification to the consumer 104 via a suitable communication method to notify the consumer 104 of the modification to their loan terms.

### Processing of Payment Transaction Data for Loan Term Modification

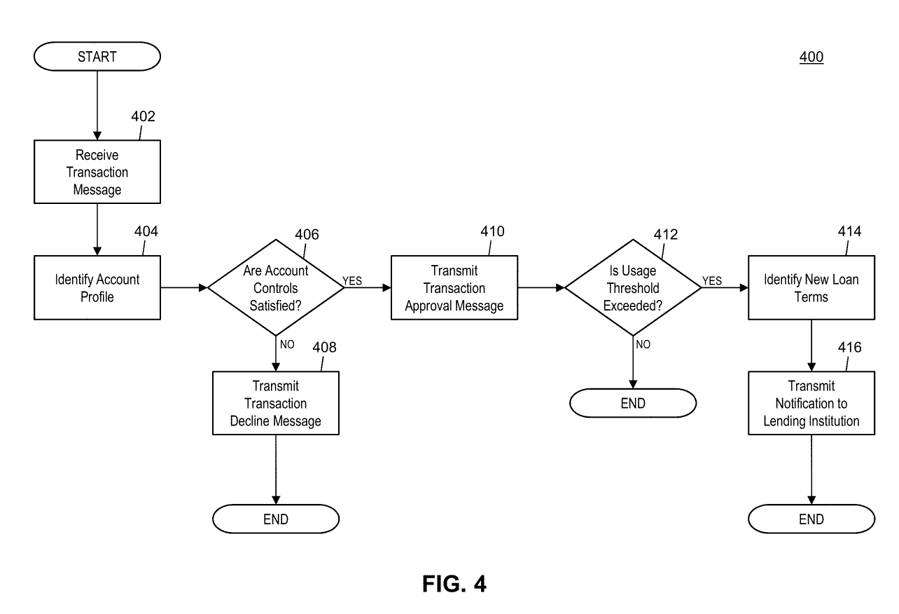

FIG. 4 illustrates a process 400 for the processing of a payment transaction by the processing server 102 to determine compliance with transaction controls and exceeding of usage thresholds for modification of loan terms.

In step 402, the receiving device 202 of the processing server 102 may receive a transaction message for a payment transaction from the payment network 114, issuing institution 108, or other suitable entity. The transaction message may be formatted pursuant to one or more standards, such as the ISO 8583 or ISO 20022 standards and include a plurality of data elements including at least a first data element configured to store a primary account number and one or more additional data elements configured to store additional transaction data. In step 404, the querying module 210 of the processing server 102 may execute a query on the account database 206 of the processing server 102 to identify an account profile 208 related to the payment transaction that includes the primary account number stored in the corresponding data element included in the received transaction message.

In step 406, the verification module 212 of the processing server 102 may determine if transaction controls set for the transaction account are satisfied by the payment transaction. The determination may be based on a check for compliance with one or more transaction controls stored in the identified account profile 208 based on the transaction data stored in the corresponding data elements included in the transaction message. In some instances, the compliance may be further based on transaction values stored in the account profile 208, which may be based on prior payment transactions. If, in step 406, the verification module 212 determines that the payment transaction does not satisfy the transaction controls, then, in step 408, the generation module 214 may generate an authorization response for the payment transaction that includes an additional data element configured to store a response code that indicates denial of the payment transaction due to the transaction controls, and the transmitting device 216 of the processing server 102 may electronically transmit the authorization response back to the payment network 114 or applicable entity.

If, in step 406, the verification module 212 determines that the transaction controls are satisfied, then, in step 410, the transmitting device 216 may electronically transmit the transaction message to the issuing institution 108 for further processing, which may forward an authorization response directly to the payment network 114 or through to the payment network 114 via the processing server 102. In step 412, the verification module 212 of the processing server 102 may verify if a usage threshold associated with the loan related to the identified account profile 208 is exceeded. In some embodiments, step 412 may only be performed if the payment transaction is approved, such as may be indicated by receipt of an authorization response or corresponding data from the issuing institution 108. The verification module 212 may verify exceeding of the usage threshold based on the transaction data stored in the additional data elements included in the transaction message and transaction values stored in the identified account profile 208 as compared to the usage threshold. If, in step 412, the usage threshold is not exceeded, then the process 400 may be completed as no further actions may be necessary.

If, in step 412, the verification module 212 determines that a usage threshold is exceeded, then, in step 414, the processing server 102 may identify new loan terms for the related loan. The new loan terms may be identified based on modification or other updating to the existing loan terms stored in the identified account profile 208. In some instances, the modifications may be predetermined, such as may be performed upon the exceeding of any usage threshold. In other instances, the loan terms that are modified, and the terms of the modifications themselves, may be based on the usage threshold that was identified as being exceeded. In step 416, the generation module 214 of the processing server 102 may generate a data message that includes the new loan terms, which may be electronically transmitted to the related lending institution 106 by the transmitting device 216 of the processing server 102.

### Exemplary Method for Modification of Loan Terms Based on Transaction Account Activity

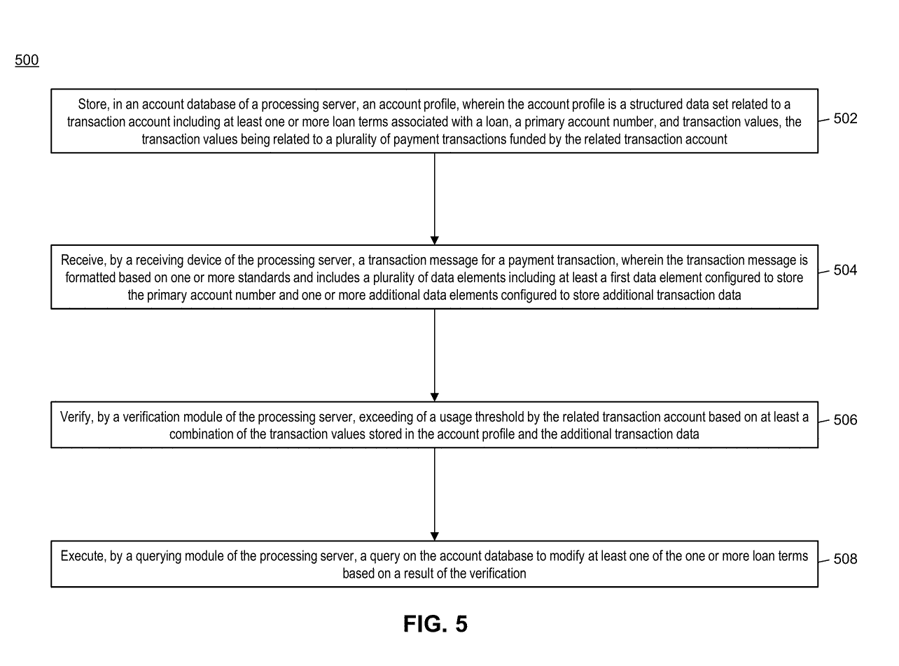

FIG. 5 illustrates a process 500 for the modification of loan terms based on transaction account activity, where loan terms are modified as a result of the exceeding of predetermined usage thresholds as identified based on transaction account activity for related transaction accounts.

In step 502, an account profile (e.g., account profile 208) may be stored in an account database (e.g., the account database 206) of a processing server (e.g., the processing server 102), wherein the account profile is a structured data set related to a transaction account including at least one or more loan terms associated with a loan, a primary account number, and transaction values, the transaction values being related to a plurality of payment transactions funded by the related transaction account. In step 504, a transaction message may be received by a receiving device (e.g., the receiving device 202) of the processing server for a payment transaction, wherein the transaction message is formatted based on one or more standards and includes a plurality of data elements including at least a first data element configured to store the primary account number and one or more additional data elements configured to store additional transaction data.

In step 506, a verification module (e.g., the verification module 212) of the processing server may verify exceeding of a usage threshold by the related transaction account based on at least a combination of the transaction values stored in the account profile and the additional transaction data. In step 508, a query may be executed by a querying module (e.g., the querying module 210) of the processing server on the account database to modify at least one of the one or more loan terms based on a result of the verification.

In one embodiment, the method 500 may further include electronically transmitting, by a transmitting device (e.g., the transmitting device 216) of the processing server, a data signal to a financial institution (e.g., the lending institution 106) associated with the loan. In a further embodiment, the data signal may further include at least the result of the verification and the usage threshold. In another further embodiment, the data signal may include at least one of the one or more loan terms. In some embodiments, the at least one of the one or more loan terms modified may be based on the exceeded usage threshold

In one embodiment, the method 500 may further include storing, in a memory (e.g., the memory 218) of the processing server, a plurality of usage thresholds, wherein the exceeded usage threshold is one of the plurality of usage thresholds. In some embodiments, the method 500 may also include executing, by the querying module of the processing server, a query on the account database to identify the account profile based on a correspondence between the included primary account number and the primary account number stored in the first data element included in the received transaction message. In one embodiment, the one or more loan terms may include at least one of: principal balance, interest rate, interest balance, number of payments, loan term, and fee amount.

In some embodiments, the account profile may further include one or more transaction controls, and the method 500 may further include verifying, by the verification module of the processing server, compliance of the payment transaction with the one or more transaction controls included in the account profile based on a correspondence between the one or more transaction controls and the additional transaction data and/or the transaction values included in the account profile. In one embodiment, the transaction values may include a plurality of transaction messages, each transaction message being related to a prior payment transaction involving the related transaction account and including a plurality of data elements configured to store transaction data for the related prior payment transaction

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, consumer 104, lending institution 106, issuing institution 108, payment card 110, merchant system 112, payment network 114, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for modification of loan terms based on transaction account activity. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for modification of loan terms based on transaction account activity, comprising:
storing, in an account database of a processing server, an account profile, wherein the account profile is a structured data set related to a transaction account including at least one or more loan terms associated with a loan, a primary account number, and transaction values, the transaction values being related to a plurality of payment transactions funded by the related transaction account;
receiving, by a receiving device of the processing server, a transaction message for a payment transaction, wherein the transaction message is formatted based on one or more standards and includes a plurality of data elements including at least a first data element configured to store the primary account number and one or more additional data elements configured to store additional transaction data;
verifying, by a verification module of the processing server, exceeding of a usage threshold by the related transaction account based on at least a combination of the transaction values stored in the account profile and the additional transaction data; and
executing, by a querying module of the processing server, a query on the account database to modify at least one of the one or more loan terms based on a result of the verification.

2. The method of claim 1, further comprising:
electronically transmitting, by a transmitting device of the processing server, a data signal to a financial institution associated with the loan.

3. The method of claim 2, wherein the data signal includes at least the result of the verification and the usage threshold.

4. The method of claim 2, wherein the data signal includes at least the modified at least one of the one or more loan terms.

5. The method of claim 1, wherein the at least one of the one or more loan terms modified is based on the exceeded usage threshold.

6. The method of claim 1, further comprising:
storing, in a memory of the processing server, a plurality of usage thresholds, wherein the exceeded usage threshold is one of the plurality of usage thresholds.

7. The method of claim 1, further comprising:
executing, by the querying module of the processing server, a query on the account database to identify the account profile based on a correspondence between the included primary account number and the primary account number stored in the first data element included in the received transaction message.

8. The method of claim 1, wherein
the account profile further includes one or more transaction controls, and
the method further comprises:
verifying, by the verification module of the processing server, compliance of the payment transaction with the one or more transaction controls included in the account profile based on a correspondence between the one or more transaction controls and the additional transaction data and/or the transaction values included in the account profile.

9. The method of claim 1, wherein the transaction values includes a plurality of transaction messages, each transaction message being related to a prior payment transaction involving the related transaction account and including a plurality of data elements configured to store transaction data for the related prior payment transaction.

10. The method of claim 1, wherein the one or more loan terms includes at least one of: principal balance, interest rate, interest balance, number of payments, loan term, and fee amount.

11. A system for modification of loan terms based on transaction account activity, comprising:
an account database of a processing server configured to store an account profile, wherein the account profile is a structured data set related to a transaction account including at least one or more loan terms associated with a loan, a primary account number, and transaction values, the transaction values being related to a plurality of payment transactions funded by the related transaction account;
a receiving device of the processing server configured to receive a transaction message for a payment transaction, wherein the transaction message is formatted based on one or more standards and includes a plurality of data elements including at least a first data element configured to store the primary account number and one or more additional data elements configured to store additional transaction data;
a verification module of the processing server configured to verify exceeding of a usage threshold by the related transaction account based on at least a combination of the transaction values stored in the account profile and the additional transaction data; and
a querying module of the processing server configured to execute a query on the account database to modify at least one of the one or more loan terms based on a result of the verification.

12. The system of claim 11, further comprising:
a transmitting device of the processing server configured to electronically transmit a data signal to a financial institution associated with the loan.

13. The system of claim 12, wherein the data signal includes at least the result of the verification and the usage threshold.

14. The system of claim 12, wherein the data signal includes at least the modified at least one of the one or more loan terms.

15. The system of claim 11, wherein the at least one of the one or more loan terms modified is based on the exceeded usage threshold.

16. The system of claim 11, further comprising:
a memory of the processing server configured to store a plurality of usage thresholds, wherein the exceeded usage threshold is one of the plurality of usage thresholds.

17. The system of claim 11, wherein the querying module of the processing server is further configured to execute a query on the account database to identify the account profile based on a correspondence between the included primary account number and the primary account number stored in the first data element included in the received transaction message.

18. The system of claim 11, wherein
the account profile further includes one or more transaction controls, and
the verification module of the processing server is further configured to verify compliance of the payment transaction with the one or more transaction controls included in the account profile based on a correspondence between the one or more transaction controls and the additional transaction data and/or the transaction values included in the account profile.

19. The system of claim 11, wherein the transaction values includes a plurality of transaction messages, each transaction message being related to a prior payment transaction involving the related transaction account and including a plurality of data elements configured to store transaction data for the related prior payment transaction.

20. The system of claim 11, wherein the one or more loan terms includes at least one of: principal balance, interest rate, interest balance, number of payments, loan term, and fee amount.
